(19) United States
(12) Patent Application Publication
(10) Pub. No.: US 2011/0015814 A1
(43) Pub. Date: Jan. 20, 2011

(54) CHARGING STATION WITH SOLAR PANELS

(76) Inventors: Gary Starr, Santa Rosa, CA (US); Bao Tran, Saratoga, CA (US)

Correspondence Address: TRAN & ASSOCIATES, P.O. Box 68, Saratoga, CA, 95071-0068, US

(21) Appl. No.: 12/728,231

(22) Filed: Mar. 21, 2010

Related U.S. Application Data
(60) Provisional application No. 61/174,336, filed on Apr. 30, 2009.
(60) Provisional application No. 61/295,043, filed on Jan. 14, 2010.

(51) Int. Cl. G06F 19/00; H01M 10/46; G06Q 20/00; G06F 7/04

(52) U.S. Cl. 701/22; 320/101; 235/380; 340/5.54; 340/5.52; 340/5.53

(57) ABSTRACT

A parking meter includes a solar panel; a power regulator coupled to the solar panel; a battery coupled to the power regulator; and a parking meter coupled to the power regulator and the battery and having a power receptacle adapted to recharge a vehicle battery.

This application claims priority to U.S. Application Ser. No. 61/174,336, filed Apr. 30, 2009 and to Ser. No. 61/295,043 filed Jan. 14, 2010, the contents of which are incorporated by reference.

### BACKGROUND

The present invention relates to rapid recharging circuits and recharging stations for electric vehicles.

Battery electric vehicles has been developed more than a century ago, yet the usage of plug-in battery electric vehicles is still limited to some short distance, low speed transportation such as golf carts, commuting carts in big buildings and manufacturing facilities and handicap vehicles. Although many different models of electric cars have been developed, none of them have achieved the market acceptance of vehicles powered by internal combustion engines.

However, recent awareness of human activity's impacts on environment pollution has propelled the need to develop green vehicle alternatives to gasoline powered vehicles such as electric vehicles. At present trend, there will be 2.5 billion vehicles on the planet by 2050, up from 600 million this year. The continued economic development of India, China and Brazil will lead to a staggering increase in the number of vehicles on the world's roads. Thus, electrification of short-haul transportation becomes the only viable alternative.

One issue with electric vehicles is the battery capacity/weight. At current, most electric cars offer a range of 50-60 miles before they need to be recharged. However, most garages or parking meters do not offer power plugs to recharge these cars. Moreover, if electric vehicles become the dominant mode of transportation, the collective power required to recharge these vehicles can become a significant load on the existing power grid.

U.S. Pat. No. 4,532,418 discloses a structure for charging an electric vehicle at a parking location and facilitating billing for the charging energy utilized and the parking time. The structure includes a charging and parking meter at a parking space for receiving a charge card and into which a charging plug from an electric vehicle may be placed, structure for reading the charge card placed in the meter and for locking the plug in place, and a central processor unit for determining the charging energy used and parking time and for storing billing data relative thereto at a remote location, for periodic removal to facilitate billing. The parking meter permits charging of an electric vehicle at a parking location in response to use of a charge card and stores charging and parking information for subsequent retrieval to facilitate billing to the owner of the charge card.

### SUMMARY

In one aspect, a parking meter includes a solar panel; a power regulator coupled to the solar panel; a battery coupled to the power regulator; and a parking meter coupled to the power regulator and the battery and having a power receptacle adapted to recharge a vehicle battery.

In another aspect, a parking meter includes a solar panel, a power receptacle adapted to recharge a vehicle battery; an electrically-controlled door to control access to the power receptacle; and an access control device to open the door and to supply power to the power receptacle after authorization.

In one implementation, an automated door is provided to allow users a secure access to the recharging receptacle. Once the user has been authorized or otherwise authenticated, the charger has an on light and automatic door opening system that activates the power to the plug. The authorization can be done with a smart card, credit card, a user password, a code through a key card, a biometric thumb print, or a combination of the foregoing. The authorization can also be done by inserting coins or paper money, among others. The charger station can be used by anyone who possesses any of the above or alternatively by users with a manual entered pin code if smart card is utilized.

In another aspect, a parking meter includes an access control device to uniquely identify a vehicle based on wireless communication with the vehicle; and a plurality of power connections to distribute electricity to charge in parallel a plurality of battery sets in the vehicle. The battery sets may form an exterior body of the vehicle.

Implementations of the vehicle may include one or more of the following. The vehicle may include a plurality of sets of rechargeable batteries, each set having a dedicated charger for distributed recharging of the batteries, the batteries forming an outer exterior of the vehicle; and a power cable linking the composite body panels, each power cable transmitting data to and from the composite body panels. The power cable can be a coaxial cable or a power cable and a data cable. The data cable can be a fiber optic cable. The data cable can also be an Ethernet cable. The data can be an Internet Protocol (IP) in the cable. Each body panel can have a battery recharger. The body panel can be made of lithium ion batteries. The batteries can have a shape that conforms to a specific shape such as a door or a hood or a seat, for example. To protect the occupant, a beam can be used that transfers a crash load into the vehicle body and away from a passenger cabin. Additionally, driver and passenger air bags positioned in the vehicle body. A wireless transceiver can be connected to the power cable. The wireless transceiver sends status of components in the vehicle to a remote computer. The wireless transceiver communicates maintenance information to a remote computer. If needed, the remote computer orders a repair part based on the maintenance information and schedules a visit to a repair facility to install the repair part.

Advantages of the preferred embodiment may include one or more of the following. The system charges electric vehicles with reduced load on the power grid. The system distributes recharging energy so replenishing the battery can be done quickly and in a distributed manner. Cost is minimized since overhead charging control components are centralized in a controller. The actual energy transfer switches are distributed to minimize energy losses. The system is distributes the power consumption during recharging of vehicle batteries.

### BRIEF DESCRIPTION OF THE DRAWINGS

FIG. 1 shows an exemplary block diagram of a recharging parking meter with a solar recharger.

FIG. 2 shows an exemplary embodiment of the recharging parking meter with solar power capability.

FIG. 3 shows an exemplary environmentally friendly vehicle.

FIG. 4 illustrates an exemplary battery system and an exemplary power cable system for a car.

FIG. 5 shows an exemplary car electronic system.

### DESCRIPTION

Methods and apparatus that implement the embodiments of the various features of the disclosure will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment. Throughout the drawings, reference numbers are re-used to indicate correspondence between referenced elements. In addition, the first digit of each reference number indicates the figure in which the element first appears.

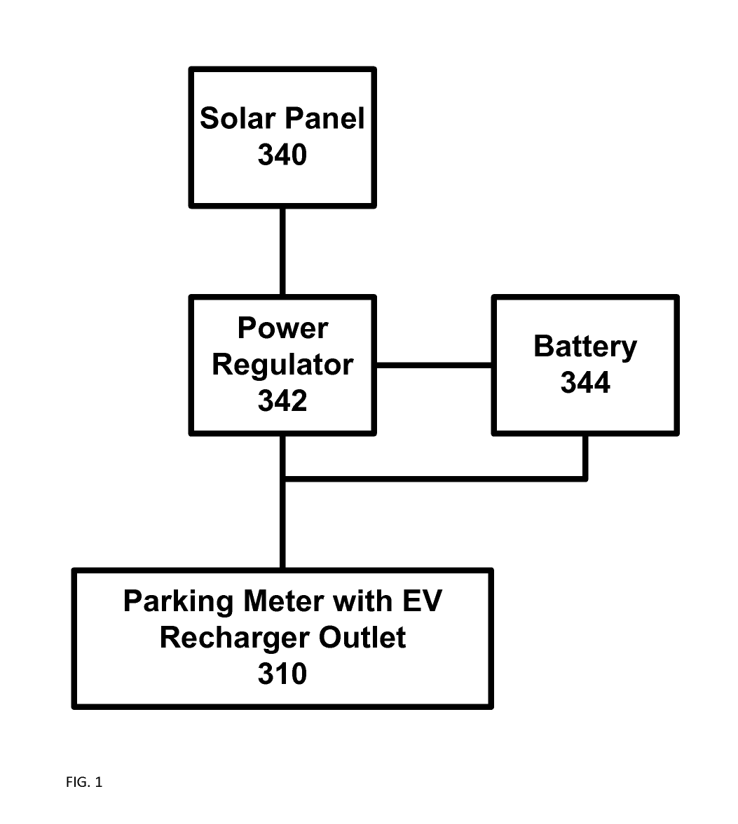

FIG. 1 shows an exemplary block diagram of a recharging parking meter with a solar recharger. A solar panel 340 captures solar energy and converts the solar energy into a DC voltage and such DC voltage is supplied to a DC converter or regulator 342. The output of the DC converter or regulator 342 is provided either directly to a parking meter 310 and/or to a battery for storing the energy until needed. When needed (such as after darkness), the battery 344 supplies power to the parking meter. In this manner, the parking meter can operate without requiring energy from the grid.

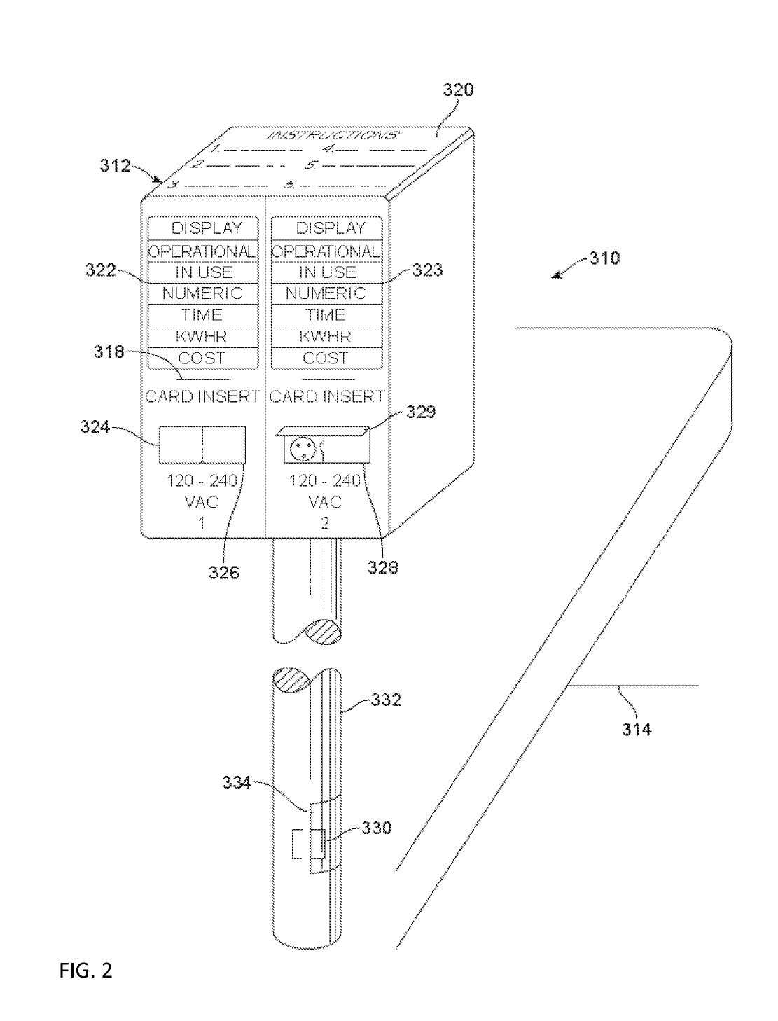

FIG. 2 shows an exemplary parking meter with solar recharging capability. In one embodiment, the electric vehicle charging and parking meter system structure 310 includes a meter 312 positioned adjacent a parking space 314 and a microprocessor (not shown) connected to the meter 312 for computing and storing time, electrical energy use and cost data for vehicles parked in the parking space 314. The microprocessor stores time, kilowatt hour and cost data for transmission to a central billing computer determine and collect fees from the car owner who used the meter 312.

In use, a series of charging and parking meters 312 are placed at a location along a street or a parking facility and supplying alternating current, as for example, 120 or 240 volt A.C., thereto. In one embodiment, the electric vehicles have distributed chargers, one for each group of batteries, for converting the alternating current energy available at the meter structures 312 to direct current and for controlling the state of charge of the vehicle batteries. The distributed chargers enable each group of batteries to be charged separately, thus avoiding the bottleneck of one set of battery slowing down the charging of another set. Also, power can be provided in parallel rather than sequentially.

Preferably, a wireless control device in the car transmits financial information to the meter 312 to enable power to be provided to the charging cord plug to the meter 312. In one embodiment, the wireless control device can be a cell phone communicating with the meter 312 using Bluetooth, ZigBee (802.15) or WiFi (802.11). Alternatively, to facilitate use by one time users who do not have an account, the charging can be facilitated by inserting a charge card into the meter 312, through slot 318, and connecting the electric vehicle's charging cord plug to the meter 312.

A plurality of voltage sources, for example, solar DC power plug 323 and 120 and 240 volt A.C. power plugs 324 and 326, respectively, can be provided on the meter 312. The DC power plug 323 can provide power from an external DC source as well as power from the solar panel 340 to power the charging electronics in the meter 312. The voltage sources 324 and 326 are provided with a sliding cover 328 so that only one will be available at any one time, and are further provided with a separate spring loaded cover 329 to protect the voltage sources when not in use. A ground fault interrupter breaker 30 is provided in the meter post 332 with access through the post door 334.

The meter 312 includes a display 322 or 323 to provide user feedback. The display 322 or 323 can be a touch screen display to capture user input as well. The meter structure 312 includes the separate operational display structure 322 and numeric display structure 323, also includes the plug lock mechanism 338 and card reader 340. The plug lock mechanism 338 is operable on an instruction from the wireless transceiver on the vehicle or on the first insertion of a charge card to lock a vehicle's electric charging cord plug to the meter structure 312 and to release the plug from the meter structure 312 on the second insertion of a charge card in the meter 310. The card reader 340 functions to identify the presence of a card in the meter 310 and to validate the card in accordance with identification parameters on the card.

In one embodiment, an automated door is provided to allow users a secure access to the recharging receptacle. Once the user has been authorized or otherwise authenticated, the charger has an on light and automatic door opening system that activates the power to the plug. The authorization can be done with a smart card, credit card, a user password, a code through a key card, a biometric thumb print, or a combination of the foregoing. The authorization can also be done by inserting coins or paper money, among others. The charger station can be used by anyone who possesses any of the above or alternatively by users with a manual entered pin code if smart card is utilized.

The electric vehicle charging and parking meter system structure 310 includes an overload detector for sensing charging circuit overloads, an open circuit detector for sensing an open charging circuit, a kilowatt transducer for determining energy used in charging of the electric vehicle, and a time clock for aiding in the determination of the energy used in charging the vehicle, and in determination of the time of parking the vehicle. A power breaker is provided for connecting and disconnecting the power to the electric vehicle being charged. The breaker is activated or deactivated by customer request or a system fault.

A series of charging and parking meters 312 can be connected to a single microprocessor unit, which unit could be contained in one of the charging and parking meter enclosures to serve more than one charging and parking meter, or could be located in a nearby protected area to serve a group of charging and parking meters.

The charging and parking meters 312 may be made to service, one, two, three, four, five or more electric vehicles including automobiles, electric scooters, electric bicycles, electric motorbikes, electric vans, among others. The charging and parking meters would function as a means of charging electric batteries when the owners are away from their residence. It is therefore contemplated that the charging and parking meters would be located at shopping centers, indoor and outdoor theaters, parking garages, on-street and off-street parking spaces, or any other location where an electric vehicle owner may park for an extended time. Thus, the range of an electric vehicle can be extended.

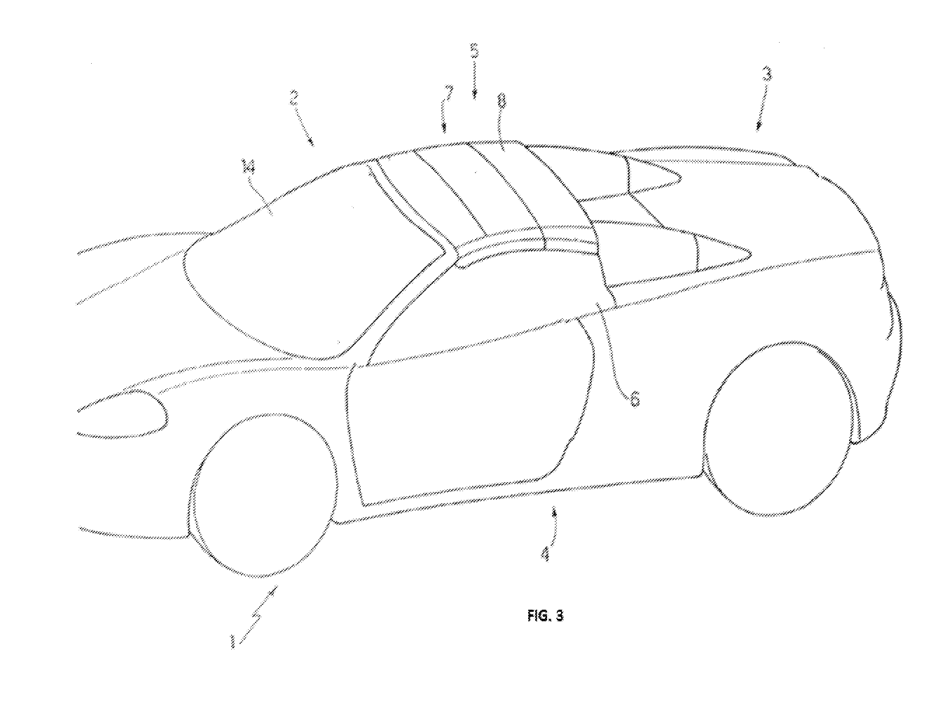

FIG. 3 shows an exemplary environmentally friendly vehicle such as a car 1 with a passenger compartment 2 and a central engine compartment 3 behind passenger compartment 2 with a front window 14 and one or more side windows and a rear window. Although the engine compartment 3 is shown as a rear-engine, the engine compartment 3 can also be affront engine compartment. The engine can be all electric engine, hydrogen engine, hybrid engine, or an ultra low emission gas engine. To minimize emission, the ULEG engine can be turned off when stopped, or the cylinders can be disabled if the full power is not needed.

A frame 4 of the car 1 supports a roof 5 which can be a sun roof that can expose the passenger compartment 2 in an open position and can cover the passenger when closed. To support the sun roof, the frame 4 provides two vertical posts 6 facing each other on opposite sides of car 1, at the boundary between passenger compartment 2 and engine compartment 3. When sun roof 5 is in the closed position, roof members 7 and 8 are substantially horizontal, substantially coplanar, and positioned seamlessly one behind the other. The car contains a cooling system that minimizes the weight and power consumption of conventional air conditioning system for the car 1.

In one embodiment, the vehicle exterior body can be a laminate defining the chamber and piping connected to the chamber. The vehicle exterior body can be a lightweight composite material. Composite body structures provide an impact-resistant exterior that is lighter than steel but three times as strong. The car can include front crash zones that absorb and deflect energy to keep the passenger from harm. The car can also provide integrated high-strength aluminum door beams that transfer crash loads into the body and away from the cabin. A complement of driver and passenger air bags is incorporated to ensure that each passenger is protected and secure.

The vehicle can provide an evaporative cooling system with a fluid. The fluid can be Freon or water or any suitable evaporative fluid. Water is cheap and has no side effect. Thus, in one embodiment, the system reduces the temperature of a space by making use of the natural characteristic of water to absorb heat during its vaporization from the body with which it is in contact.

In one embodiment, evaporation can be enhanced by creating small rough surfaces on the floor of a container. Such rough surfaces can be made by blasting, sanding, or depositing small projective surfaces on the floor. The vapor eventually condenses and is subsequently collected by the liquid reservoir. A pump can circulate water needed for the vaporization according to the specific conditions of each case so that it can be kept wet on its whole surface. A wet surface such as a shroud or fabric reduces the temperature of a space by making use of the natural characteristic of water to absorb heat during its vaporization from the body with which it is in contact. It includes large wet surfaces created with a small mass of water within a limited space due to the activation of the molecular powers of water and of other material with molecular powers relevant to the ones of water.

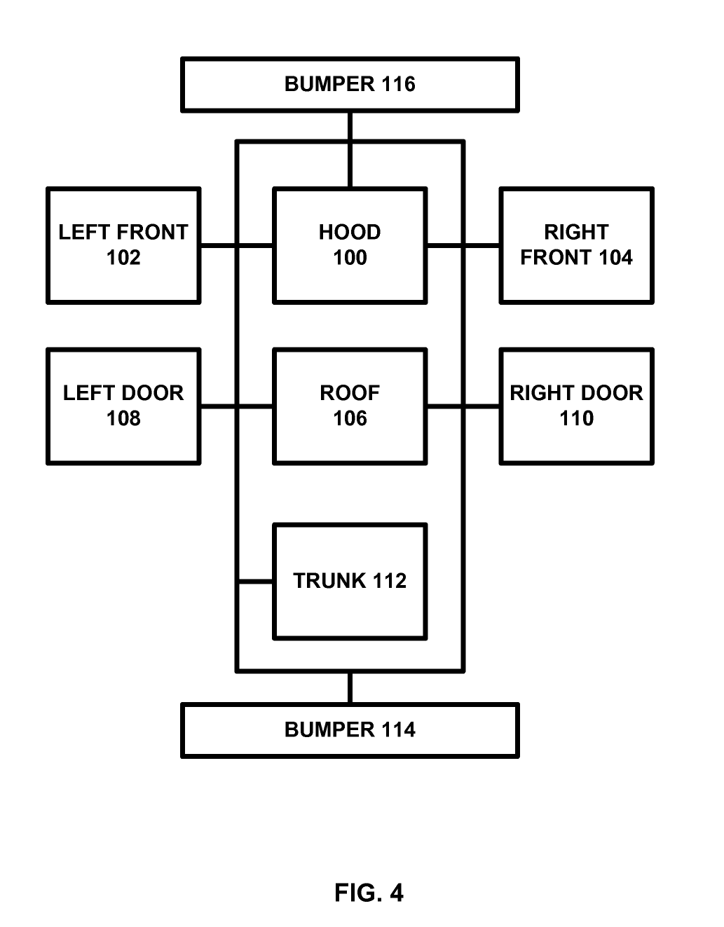

In one embodiment shown in FIG. 4, each car body part is a battery shaped to provide a particular mechanical function. The battery can be a rechargeable battery such as a lithium type battery, among others. For example, a battery shaped as hood 100 covers the engine and can be opened to allow access to the engine and other drive train components. A battery shaped left and right front portions 102, 104 covers the left and right front part of the car, while a front battery shaped bumper 116 provides protection against frontal collision. A battery shaped as a left door 108 and as a right door 110 allows passenger access to the vehicle, while a battery shaped as a roof 106 protects the occupant from sun or rain. A battery shaped as a trunk 112 covers a storage space, and a battery shaped as a bumper 114 protects the vehicle from a rear collision.

The battery can be rechargeable lithium ion, although other chemistries can be used. In one embodiment, conformal batteries such as lithium polymer batteries can be formed to fit the available space of the car body part regardless of the geometry of the part. Alternatively, for batteries that are available only in relatively standard prismatic shapes, the prismatic battery can be efficiently constructed to fill the space available, be it rectilinear or irregular (polyhedral) in shape. This conformal space-filling shape applies in all three dimensions. In one embodiment, this is done by selecting a slab of lithium polymer battery material of a desired height; freezing the slab; vertically cutting the slab to a desired shape thus forming a cut edge; attaching an anode lead to each anode conductor of the cut slab along the cut edge while maintaining the cut slab frozen; and attaching a cathode lead to a each cathode conductor of the cut slab along the cut edge while maintaining the cut slab frozen. The slab may contain one or many cells. The leads may be made of single or multistranded, metallic wire, metallic ribbon, low melting point alloy, self-healing metal, and litz wire. Attachment is accomplished so as to minimize tension on the leads. The cut slab may need to be deburred after cutting and before attaching leads. The cut edge may be inspected for burrs before deburring is performed. As discussed in US Application Serial 20070079500, the content of which is incorporated by reference, burr formation can be avoided by recessing the edge of each anodic half cell or each cathodic half cell by mechanical means, blowing away dust; and insulating the recessed edges with non-conductive polymer. Lead attachment my be accomplished by a number of methods including: wire bonding; wedge bonding; adhering the lead to the electrode with conductive epoxy, anistotropic conductive adhesive or conductive thermoplastic; stapling with microstaples; adhering the lead to the electrode by electropolymerization; welding the lead to the electrode with micro welding; and growing a lead in place by electroless plating, electro-plating or a combination of electroless plating and electroplating. The leads should be insulated. Preferably the insulation is thermoplastic. If there is more than one cell in the slab, the distal ends of the leads may be connected together so that the cells are connected together in series, in parallel or some in series and the remainder in parallel. After the leads have been attached to the cut slab and connected together, the assembly will preferably be wrapped with standard packaging for lithium polymer batteries or a shrinkable form fitting version thereof.

Because the starting material for the conformal battery is purchased pre-made from a battery manufacturer, this approach eliminates the considerable expense of formulating and producing the materials for the anodes and cathodes as well as combining the anodes and cathodes into battery cells. This reduces cost and weight for the car.

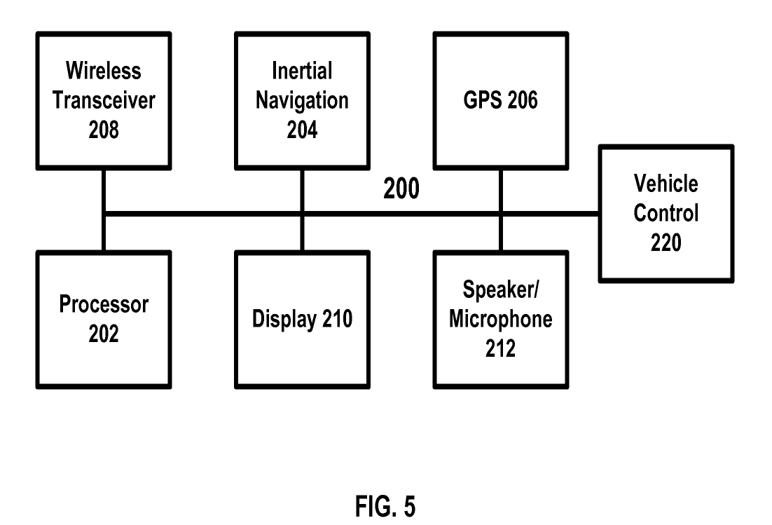

FIG. 5 shows a block diagram of an embodiment of an electrical power and automobile control system. The system is controlled by a processor 202. The processor 202 is connected with an inertial system (INS) 204 and a global positioning system (GPS) receiver 206 that generate navigation information. The processor 202 is also connected with a wireless communication device 208 that transmits and receives digital data as well as being a Doppler radar when desired. The processor 202 drives a display 210 and a speaker 212 for alerting a driver. The processor 202 provides control inputs to the automobile's braking and steering systems 220. A power cable 200 carries power between the batteries 100-116 and an electric motor engine (not shown). The power cable 200 also carries power to recharge the batteries 100-116 serially or in parallel as discussed above.

The power cable 200 can be a coaxial cable or a power cable and a data cable. In one embodiment, the same wire carrying power also carries data. Data in the form of radio frequency (RF) energy can be bundled on the same line that carries electrical current. Since RF and electricity vibrate on different frequencies, there is no interference between the two. As such, data packets transmitted over RF frequencies are not overwhelmed or lost because of electrical current. Eventually, the data can be provided to wireless transmitters that will wirelessly receive the signal and send the data on to computer stations. Exemplary protocols that can be used include CAN-bus, LIN-bus over power line (DC-LIN), and LonWorks power line based control. In one embodiment, the protocol is compatible with the HomePlug specifications for home networking technology that connects devices to each other through the power lines in a home. Many devices have HomePlug built in and to connect them to a network all one has to do is to plug the device into the wall in a home with other HomePlug devices. In this way, when the vehicle is recharged by plugging the home power line to the vehicle connectors, automotive data is automatically synchronized with a computer in the home or office.

Alternatively, two separate transmission media can be used: one to carry power and a second to carry data. In one embodiment, the data cable can be a fiber optic cable while the power cable can be copper cable or even copper coated with silver or gold. The data cable can also be an Ethernet cable. The data can be an Internet Protocol (IP) in the cable. Each body panel can have a battery recharger. The body panel can be made of lithium ion batteries. The batteries can have a shape that conforms to a specific shape such as a door or a hood or a seat, for example. To protect the occupant, a beam can be used that transfers a crash load into the vehicle body and away from a passenger cabin. Additionally, driver and passenger air bags positioned in the vehicle body. A wireless transceiver can be connected to the power cable. The wireless transceiver sends status of components in the vehicle to a remote computer. The wireless transceiver communicates maintenance information to a remote computer. If needed, the remote computer orders a repair part based on the maintenance information and schedules a visit to a repair facility to install the repair part.

This embodiment includes navigation systems, the INS 204 and the GPS receiver 206. Alternate embodiments may feature an integrated GPS and INS navigation system or other navigation system. The use of only an INS 204 or only a GPS receiver 206 as the sole source of navigation information is also contemplated. Alternatively, the wireless communication device 208 can triangulate with two other fixed wireless devices to generate navigation information.

A display 210 and speaker/microphone 212 provide both visual and audio situational awareness information to a driver. Alternate embodiments may feature only a display 210 or only a speaker 212 as the sole source of information for the driver. Embodiments that interact directly with the braking and steering systems that provide no audio information to the driver are also contemplated.

The INS 204 supplies the processor 202 with navigation information derived from accelerometers and angular position or angular rate sensors. The processor 202 may also provide the INS 204 with initial position data or periodic position updates that allow the INS 204 to correct drift errors, misalignment errors or other errors.

The INS 204 may be a standard gimbal or strapdown INS having one or more gyroscopes and substantially orthogonally mounted accelerometers. Alternatively, the INS 204 may have accelerometers and microelectromechanical systems (MEMS) that estimate angular position or angular rates. An INS 204 having a gyroscope for detecting automobile heading and a speed sensor is also contemplated.

The GPS receiver 206 supplies the processor 202 with navigation information derived from timing signal received from the GPS satellite constellation. The processor 202 may provide the GPS receiver 206 with position data to allow the GPS receiver 206 to quickly reacquire the timing signals if the timing signals are temporarily unavailable. GPS timing signal may be unavailable for a variety of reasons, for example, antenna shadowing as a result of driving through a tunnel or an indoor parking garage. The GPS receiver 206 may also have a radio receiver for receiving differential corrections that make the GPS navigation information even more accurate.

The INS 204 and the GPS receiver 206 are complementary navigation systems. The INS 204 is very responsive to changes in the trajectory of the automobile. A steering or braking input is sensed very quickly at the accelerometers and the angular position sensors. INS 204 position and velocity estimates, however, are derived by integrating accelerometer measurements and errors in the estimates accumulate over time. The GPS receiver 206 is not generally as responsive to changes in automobile trajectory but continually estimates position very accurately. The use of both the INS 204 and the GPS receiver 206 allows the processor 202 to estimate the automobile's state more accurately than with a single navigation system.

The wireless communication device 208 receives the automobile's navigated state vector from the processor 202. The wireless communication device 208 device broadcasts this state vector for use by neighboring automobiles. The wireless communication device 208 also receives the state vectors from neighboring automobiles. The received state vectors from the neighboring automobiles are sent to the processor 202 for further processing. The automobile state vector may have more or less elements describing the state of the vehicle such as the XYZ position and 3D velocity of the vehicle and 3D acceleration. Other information may be provided. For example the state vector may contain entries that describe the angular position, the angular rates, and the angular accelerations. The state vector may be described using any coordinate system or any type of units. The state vector may also contain information about the vehicle such as its weight, stopping distance, its size, its fuel state etc. Information packed in the state vector may be of value in collision avoidance trajectory analysis or may be useful for generating and displaying more accurate display symbology for the driver. For example, the automobile may receive a state vector from a neighboring vehicle that identifies the vehicle as an eighteen wheel truck with a ten ton load. Such information may be important for trajectory analysis and for providing accurate and informative display symbology.

The wireless communication device 208 may be part of a local area wireless network such as an IEEE 802.11 network. The local area network may be a mesh network, ad-hoc network, contention access network or any other type of network. The use of a device that is mesh network enabled according to a widely accepted standard such as 802.11(s) may be a good choice for a wireless communication device 208. The wireless communication device 208 may also feature a transmitter with low broadcast power to allow automobiles in the area to receive the broadcast signal. The broadcast of state vectors over a broad area network or the internet is also contemplated.

The display 210 and the speaker 212 are features that provide the driver with situational awareness. The processor 202 sends commands to the display 210 and the speaker 212 that alert the driver to hazards. The display 210 may for example show the relative positions and velocities of neighboring vehicles. The display 210 may also warn the driver to slow down or apply the brakes immediately. The speaker 212 may give aural warnings such as “STOP” or “CAUTION VEHICLE APPROACHING”.

The braking and steering systems 220 may also be commanded by the processor 202. The processor 202 may command that the brakes be applied to prevent collision with a vehicle ahead or may provide a steering input to prevent the driver from colliding with a vehicle. The processor 202 may also issue braking or steering commands to minimize the damage resulting from a collision as discussed in United States Patent Application 20080091352, the content of which is incorporated by reference.

It should be understood, of course, that the foregoing relates to exemplary embodiments of the invention and that modifications may be made without departing from the spirit and scope of the invention as set forth in the following claims.

What is claimed is:

1. A parking meter, comprising:
a solar panel;
a power regulator coupled to the solar panel;
a battery coupled to the power regulator; and
a parking meter coupled to the power regulator and the battery and having a power receptacle adapted to recharge a vehicle battery.

2. The parking meter of claim 1, comprising an electrically-controlled door to control access to the power receptacle; and an access control device to open the door and to supply power to the power receptacle after authorization.

2. The parking meter of claim 2, comprising an indicator light coupled to the access control device to indicate authorization and activation of power to the power receptacle.

3. The parking meter of claim 2, comprising a plurality of power connections to distribute electricity to charge in parallel a plurality of battery sets in a vehicle.

4. The parking meter of claim 2, wherein the access control device reads a credit card and charges the credit card prior to opening the door and supplying power to the power receptacle.

5. The parking meter of claim 2, wherein the access control device reads a smart card and charges the smart card prior to opening the door and supplying power to the power receptacle.

6. The parking meter of claim 2, wherein the access control device reads a code or password from a user and opens the door and supplies power to the power receptacle.

7. The parking meter of claim 2, wherein the access control device reads a biometric scan of a user and opens the door and supplies power to the power receptacle.

8. The parking meter of claim 2, wherein the access control device scans a thumb print from a user and opens the door and supplies power to the power receptacle.

9. The parking meter of claim 1, wherein the battery comprises a vehicle body.

10. A system, comprising:
a vehicle having a vehicle battery; and
a parking meter, including:
a solar panel to convert sunlight into electricity;
a power regulator coupled to the solar panel and to a solar panel battery;
a power receptacle coupled to the solar panel battery and adapted to recharge the vehicle battery;
an electrically-controlled door to control access to the power receptacle; and
an access control device to open the door and to supply power to the power receptacle after authorization.

11. A vehicle, comprising
a plurality of sets of rechargeable batteries, each set having a dedicated charger for distributed recharging of the batteries; and
a charging cord coupled to the dedicated chargers and adapted to plug into a parking meter having
a solar panel to convert sunlight into electricity;
a regulator coupled to the solar panel;
a power receptacle coupled to the regulator adapted to recharge a vehicle battery;
an electrically-controlled door to control access to the power receptacle; and
an access control device to open the door and to supply power to the power receptacle after authorization.

12. The vehicle of claim 11, comprising a transceiver in the parking meter to send status of components in the vehicle to a remote computer.

13. The vehicle of claim 11, wherein the transceiver communicates maintenance information to a remote computer.

14. The vehicle of claim 13, wherein the remote computer orders a repair part based on the maintenance information and schedules a visit to a repair facility to install the repair part.

15. The vehicle of claim 1, comprising a power line network device coupled to the power receptacle, the power line network device communicating vehicular information over a power line network to a remote computer.

16. The vehicle of claim 15, wherein the power line network communicates with USB protocol or Firewire protocol.

17. The vehicle of claim 1, wherein each set of rechargeable batteries are electrically isolated during charging and electrically connected thereafter.
